(19) United States
(12) Patent Application Publication
(10) Pub. No.: US 2013/0152382 A1
(43) Pub. Date: Jun. 20, 2013

(54) METHOD FOR MAKING WAVE-SHAPED HEATING UNIT

(71) Applicant: SHU-LIEN CHEN, Taichung (TW)

(72) Inventor: SHU-LIEN CHEN, Taichung (TW)

(21) Appl. No.: 13/717,712

(22) Filed: Dec. 18, 2012

(30) Foreign Application Priority Data
Dec. 20, 2011 (TW) 100147259

(51) Int. Cl. B23P 15/26

(52) U.S. Cl. CPC B23P 15/26
USPC 29/611

(57) ABSTRACT

A method for making a wave-shaped heating unit and includes a step of preparing a housing by compressing a metal tube to form an elongate tube with an oval cross section; a step of inserting a heating plate by inserting a soft heating plate into the housing, and two respective first ends of two wires connected to the heating plate; a step of clamping by compressing the elongate tube to clamp the heating plate within the housing, two respective second ends of the two wires extending beyond the housing, and a step of forming wave-shape by bending the housing into continuous convex portions and concaved portions.

### FIELD OF THE INVENTION

The present invention relates to a method for making a heating unit, and more particularly, to a method for making a wave-shaped heating unit.

### BACKGROUND OF THE INVENTION

The conventional heating unit is disclosed in FIG. 1 and generally comprises a thin heating plate 1, two wires 2 and two thermo-conductive plates 3, wherein the heating plate 1 is composed of a circuit plate 4 on which a circuit 5 is formed. The circuit 5 is made by conductive material and two ends of the circuit 5 are connected with the two wires 2 so that when current passes through the circuit 5, the circuit 5 generates heat. The thermo-conductive plates 3 are made by thermo-conductive and thermo-durable material, and the heating plate 1 is located between the two thermo-conductive plates 3, such that the thermo energy can be passed to outside by the thermo-conductive plates 3.

However, the heating plate 1 is located between the two thermo-conductive plates 3, so that the heating plate 1 is not directly in contact with the outside and the circuit 5 can be avoided from oxidation, and the life of the heating unit is prolonged.

The conventional heating unit can be made to have different shapes. When the heating unit is to be made as a wave-shaped unit, the elongate heating plate 1 is put between the two the heating plate 1 is located between the two thermo-conductive plates 3 to form an elongate combination which is then pressed by the use of molds to be wave-shaped. However, during the pressing, the circuit 5 can be broken and the heating unit cannot function properly. Alternatively, the two thermo-conductive plates 3 are shaped to be wave-shaped first, and the heating plate 1 is then put between the two thermo-conductive plates 3. The two ways of manufacturing have to use rivets to fix the combination of the heating plate 1 and the two thermo-conductive plates 3. This increases the steps of assembling and the thickness is increased.

Besides, as shown in FIG. 2, the two thermo-conductive plates 3 are welded to seal the sides of the heating unit. The sealed sides 6 are in contact with the two thermo-conductive plates 3 to keep outside air from being in contact with the heating plate 1.

The heating plate 1 is located between the two thermo-conductive plates 3, and the sealed sides 6 are formed by way of welding to form the heating unit. The heating unit then is treated to be shaped as wave-shaped. During the manufacturing processes, relative stresses are applied to the sealed sides 6 and the two thermo-conductive plates 3 such that the sealed sides 6 may be peeled off. If the heating unit is shaped to be wave-shaped and the welding processes are applied to form the sealed sides 6, the welding actions will be difficult because of the wave shaped.

The present invention intends to provide a method for making the wave-shaped heating unit and the method also improves the shortcomings of the conventional method.

### SUMMARY OF THE INVENTION

The present invention relates to a method for making a wave-shaped heating unit and the method comprises the following steps:

a step of preparing a housing: preparing metal tube and compressing the metal tube so as to form an elongate tube with an oval cross section;

a step of inserting a heating plate: inserting a soft heating plate into the housing, two respective first ends of two wires connected to the heating plate;

a step of clamping: compressing along a short axis of the elongate tube to clamp the heating plate within the housing, two respective second ends of the two wires extending beyond the housing, and

a step of forming wave-shaped: bending the housing to be wave-shaped, bending one end of the housing into a convex portion, a concaved portion being bent and connected to the convex portion, repeating the bending actions to form multiple alternative convex portions and concaved portions.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional heating unit;

FIG. 2 is a perspective view to show a wave-shaped conventional heating unit;

FIG. 3 illustrates the steps of the first embodiment of the method of the present invention;

FIG. 4 shows the housing of the first embodiment of the method of the present invention;

FIG. 5 shows that the heating plate is inserting into the housing of the first embodiment of the method of the present invention;

FIG. 6 shows that the heating plate is clamped in the housing of the first embodiment of the method of the present invention;

FIG. 7 is a cross sectional view to show that the heating plate is clamped in the housing of the first embodiment of the method of the present invention;

FIG. 8 shows a convex portion is formed to the first embodiment of the wave-shaped heating unit of the present invention;

FIG. 9 shows a convex portion and a concaved portion are formed to the first embodiment of the wave-shaped heating unit of the present invention;

FIG. 10 shows multiple convex portions and concaved portions are formed to the first embodiment of the wave-shaped heating unit of the present invention;

FIG. 11 illustrates the steps of the second embodiment of the method of the present invention, and

FIG. 12 shows the cross sectional view of the heating unit made by the second embodiment of the method of the present invention.

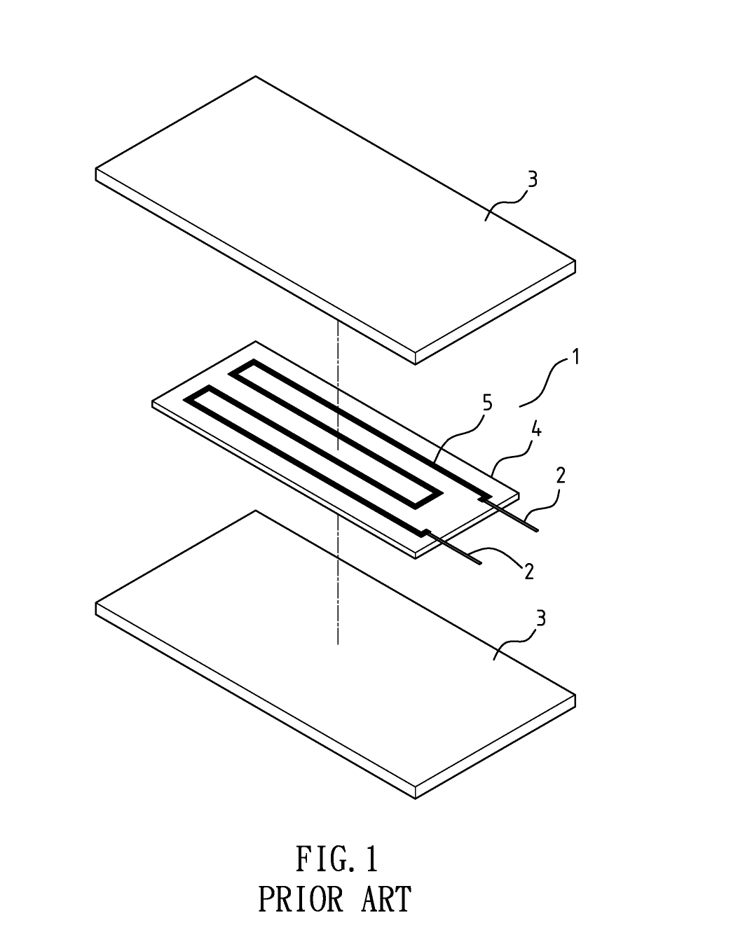

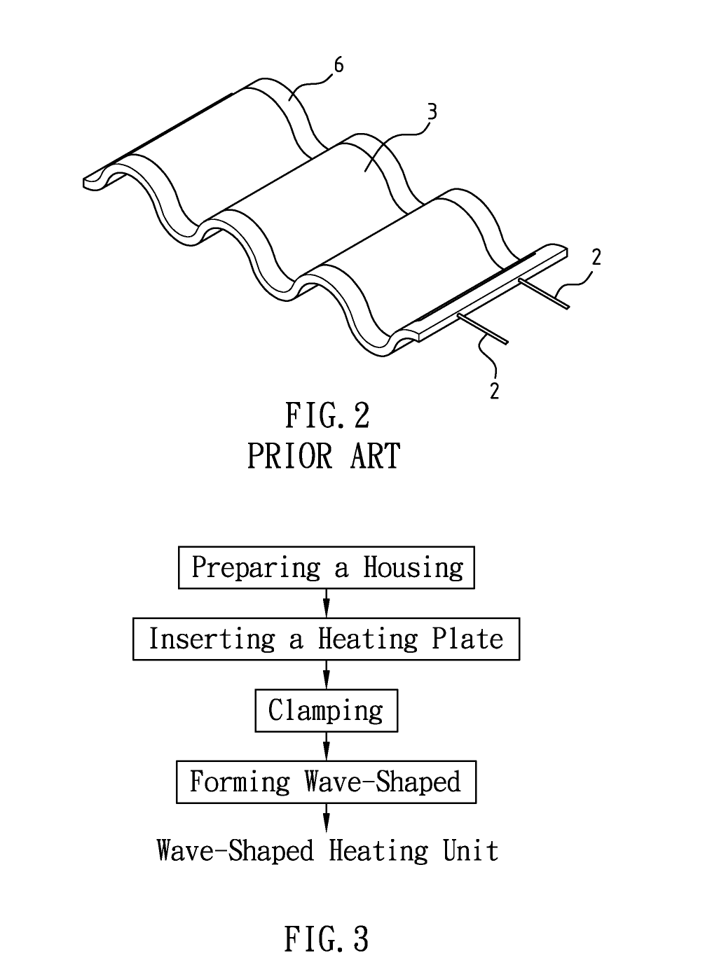

### DETAILED DESCRIPTION OF THE PREFERRED EMBODIMENT

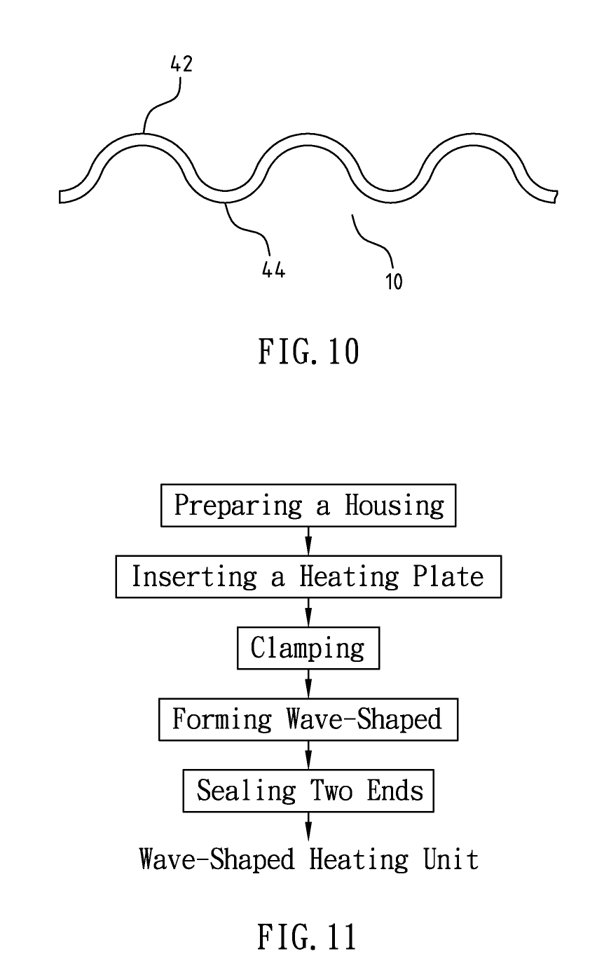

Referring to FIGS. 3 to 10, the method for making a wave-shaped heating unit of the present invention comprises the following steps:

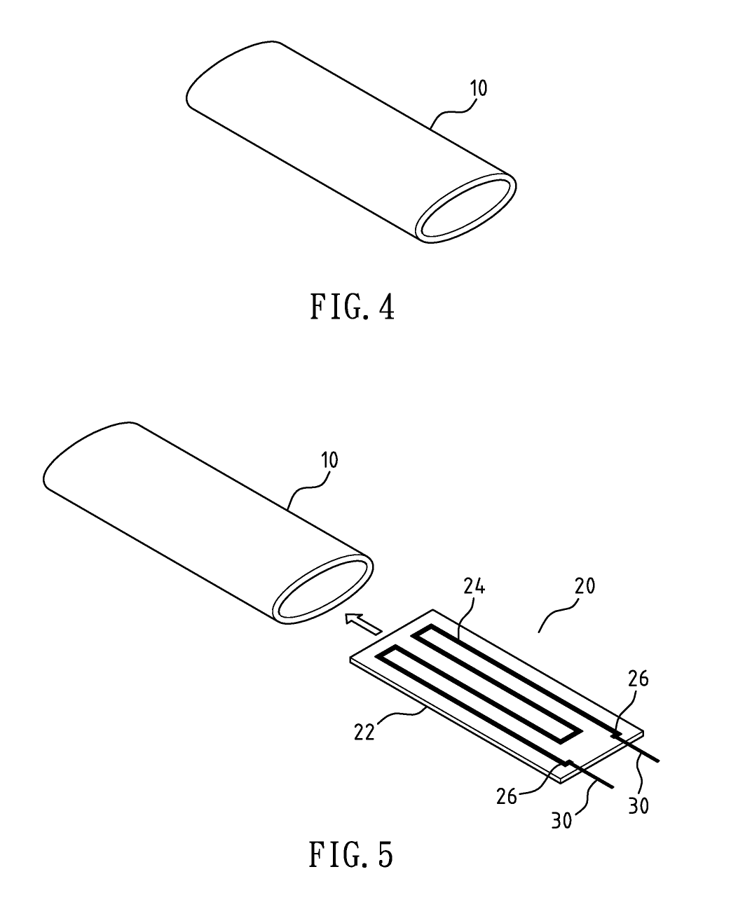

a step of preparing a housing 10: preparing metal tube and compressing the metal tube so as to form an elongate tube with an oval cross section as shown in FIG. 4;

a step of inserting a heating plate 20: inserting a soft heating plate 20 into the housing 10 as shown in FIG. 5, the two long sides of the heating plate 20 extending toward the long axis of the oval cross section of the housing 10. Two respective first ends of two wires 30 are connected to the heating plate 20. The heating plate 20 comprises a soft circuit plate 22 and a circuit 24 which is located on the circuit plate 22. The circuit 24 is formed by conductive material and has two contact points 26 at two ends thereof. The circuit 24 is electrically connected to the wires 30 by the contact points 26.

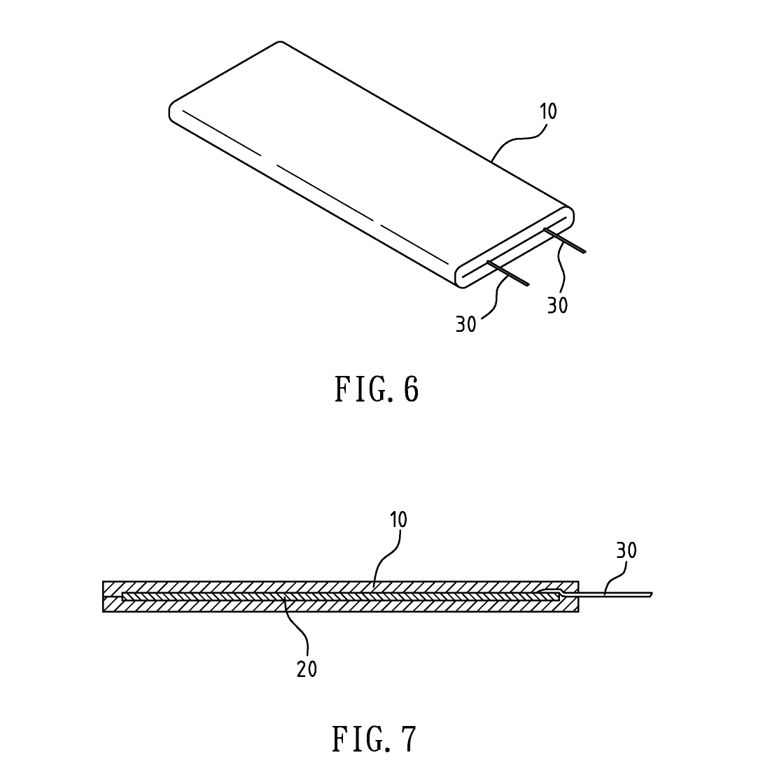

a step of clamping: compressing along the short axis of the elongate tube to clamp the heating plate 20 within the housing 10. Two respective second ends of the two wires 30 extend beyond the housing 10 so as to be connected with a power source. An elongate and flat combination of the heating plate 20 and the housing 10 is formed as shown in FIGS. 6 and 7.

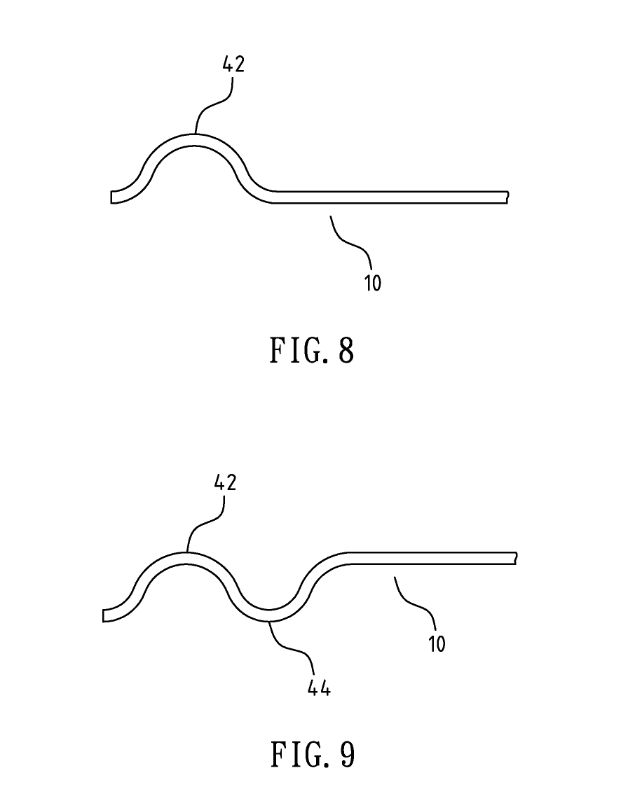

a step of forming wave-shaped: bending the housing 10 to be wave-shaped as shown in FIG. 8. One end of the housing 10 is bent into a convex portion 42, and a concaved portion 44 is then bent and connected to the convex portion 42. By repeating the bending actions, multiple alternative convex portions 42 and concaved portions 44 are formed. Therefore, the wave-shaped heating unit is formed.

During the steps, the housing 10 and the heating plate 20 are maintained without any damage so that the elongate and wave-shaped heating unit is reliable. The convex portions 42 and concaved portions 44 are formed alternative to each other, and the convex portions 42 and concaved portions 44 are continuously formed so that the inner stress of the housing 10 and the heating plate 20 can be released. Therefore, the wave shape is fixed and the heating unit can function properly.

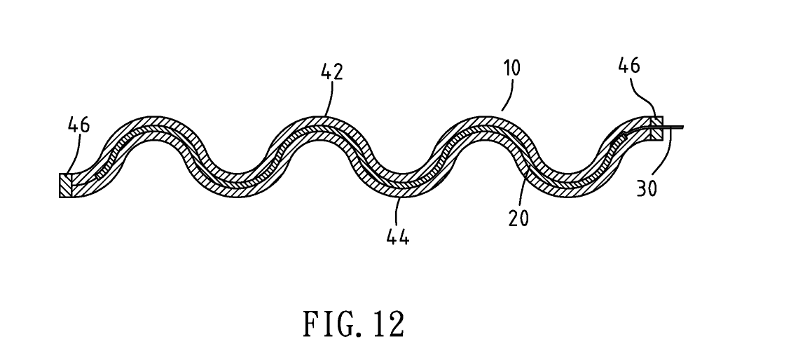

As shown in FIG. 11 which shows the second embodiment of the method of the present invention, the difference from the first embodiment is that a step of sealing is applied after the step of forming wave-shape is completed. The step of sealing is to seal two ends of the heating unit by two sealed portions 46 as shown in FIG. 12.

The two sealed portions 46 effectively avoid the outside air from being in contact with the heating plate 20. The two ends of the heating unit before the step of sealing is applied, the two ends are straight so that the sealing portions 46 are easily formed.

The wire 30 are electrically connected to the heating plate 20 so that when current passes through the heating plate 20, the heating plate 20 generates heat which is sent to outside by the housing 10. The heating unit has multiple convex portions 42 and concaved portions 44 to form the wave-shaped heating unit.

While we have shown and described the embodiment in accordance with the present invention, it should be clear to those skilled in the art that further embodiments may be made without departing from the scope of the present invention.

What is claimed is:

1. A method for making a wave-shaped heating unit, comprising:
a step of preparing a housing: preparing metal tube and compressing the metal tube so as to form an elongate tube with an oval cross section;
a step of inserting a heating plate: inserting a soft heating plate into the housing, two respective first ends of two wires connected to the heating plate;
a step of clamping: compressing along a short axis of the elongate tube to clamp the heating plate within the housing, two respective second ends of the two wires extending beyond the housing, and
a step of forming wave-shaped: bending the housing to be wave-shaped, bending one end of the housing into a convex portion, a concaved portion being bent and connected to the convex portion, repeating the bending actions to form multiple alternative convex portions and concaved portions.

2. The method as claimed in claim 1 further comprising a step of sealing which seals two ends of the heating unit by two sealed portions.

3. The method as claimed in claim 1, wherein the heating plate comprises a soft circuit plate and a circuit which is located on the circuit plate, the circuit is formed by conductive material and has two contact points at two ends thereof, the circuit is electrically connected to the wires by the contact points.
